(19) United States
(12) Patent Application Publication
(10) Pub. No.: US 2015/0011247 A1
(43) Pub. Date: Jan. 8, 2015

(54) SYSTEM AND METHOD OF TRANSMITTING DATA BETWEEN MOBILE DEVICES

(71) Applicants: Ran GILADI, Omer (IL); Shai SAUL, Tel Aviv (IL)

(72) Inventors: Ehud Ezra, Mevaseret Zion (IL); Ofer Simon, Jerusalem (IL)

(73) Assignees: Ran GILADI, Omer (IL); Shai SAUL, Tel Aviv (IL)

(21) Appl. No.: 14/379,307

(22) PCT Filed: Feb. 21, 2013
(86) PCT No.: PCT/IL2013/050156

§ 371 Date: Aug. 18, 2014

Related U.S. Application Data
(60) Provisional application No. 61/602,100, filed on Feb. 23, 2012.

(51) Int. Cl. H04W 4/02; H04W 64/00

(52) U.S. Cl. CPC H04W 4/027; H04W 64/00
USPC 455/456.3

(57) ABSTRACT

It is an object of the subject matter to disclose a method performed on two or more mobile devices comprising: detecting a movement on a sending mobile device, said sending mobile device is one of the two or more mobile devices, said movement is performed on the sending mobile device; comparing the movement performed on the sending mobile device with a positioning map, wherein the positioning map comprises relative locations of the two or more mobile devices; determining a relative location of the target mobile device on the positioning map; transmitting the data from the sending mobile device to the target mobile device.

### FIELD OF THE INVENTION

The subject matter relates generally to transmitting data from a mobile device to other nearby mobile devices.

### BACKGROUND OF THE INVENTION

Transfer of data between mobile devices requires a user of a mobile device to designate a receiving device and establish a connection with the receiving mobile device prior to transfer of the data. Transfer of the same data to multiple recipients requires establishing multiple connections which may slow down the transfer of the data.

### SUMMARY

It is an object of the subject matter to disclose a method performed on two or more mobile devices comprising: detecting a movement on a sending mobile device, said sending mobile device is one of the two or more mobile devices, said movement is performed on the sending mobile device; comparing the movement performed on the sending mobile device with a positioning map, wherein the positioning map comprises relative locations of the two or more mobile devices; determining a relative location of the target mobile device on the positioning map; transmitting the data from the sending mobile device to the target mobile device.

In some cases, the method further comprises arranging the two or more mobile devices towards a central region.

In some cases, the method further comprises designates the target mobile device to receive the data according to the movement. In some the movement is a sliding gesture.

In some cases, the method further comprises designates the target mobile device located according to the movement and an area defined by a threshold, wherein the threshold represents an area in which the sending mobile device detects a relative location of the target mobile device. In some cases, the method further comprises associating a mobile device of the two or more mobile devices with the area according to the relative location of the mobile device of the two or more mobile devices.

In some cases, the method further comprises displaying threshold lines on a display of the sending mobile device.

In some cases, the method further comprises displaying the positioning map on a display of the sending mobile device. In some cases, the positioning map is stored on a host. In some cases, the positioning map is displayed on the sending mobile device to determine a target mobile device from the two or more mobile devices. In some cases, the positioning map is stored on all of the two or more mobile devices.

In some cases, the method further comprises obtaining a mobile wireless connection between the two or more mobile devices.

It is another objective of the subject matter to disclose a system on a mobile player comprises: a display; a detection unit for detecting movements on the mobile device; a processor to determine the position of the mobile device, wherein the position is determined according to the magnetic azimuth value and proper acceleration, wherein the processor determines an orientation of the mobile device; a mapping unit to create a positioning map according to position data determined by the processor and received position data received by a transceiver, wherein the received position data is received from other mobile devices; a storage to store positioning map data created by the mapping unit, wherein the storage data stores data received from other mobile devices connected to the mobile device. In some cases, the detection unit comprises: an accelerometer to collect a proper acceleration; a magnetometer to collect a magnetic azimuth value of the mobile device. In some cases, the display displays a positioning map and threshold of mobile devices connected to the mobile device. In some cases the detection unit is a touchscreen.

In some cases, the system further comprises: a microphone; a speaker.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a system on a mobile device for creating a positioning map and transmitting data to other mobile devices, according to some exemplary embodiments of the subject matter;

FIG. 2 shows a method performed on two or more mobile devices to connect the two or more mobile devices, according to some exemplary embodiments of the subject matter;

FIG. 3 shows a method performed on a sending mobile device to transfer data between the sending mobile device and a target mobile device, according to some exemplary embodiments of the subject matter;

FIG. 4A-4G show connection of a mobile device to three other mobile devices to create a positioning map and to transfer data between the mobile device and a second mobile device of the three mobile devices, according to some exemplary embodiments of the subject matter; and,

FIG. 5 shows a configuration of mobile devices around a central region, according to some exemplary embodiments of the subject matter.

### DETAILED DESCRIPTION

The subject matter discloses a system and method to transfer data between two or more mobile devices, according to some exemplary embodiments of the subject matter. The system and method require that the two or more mobile devices to be continuously connected, for example through Bluetooth, WiFi, or the like. While the two or more mobile devices are connected, the two or more mobile devices are enabled to quickly transfer data between connected mobile devices immediately without lagging or concern about data corruption in the transfer.

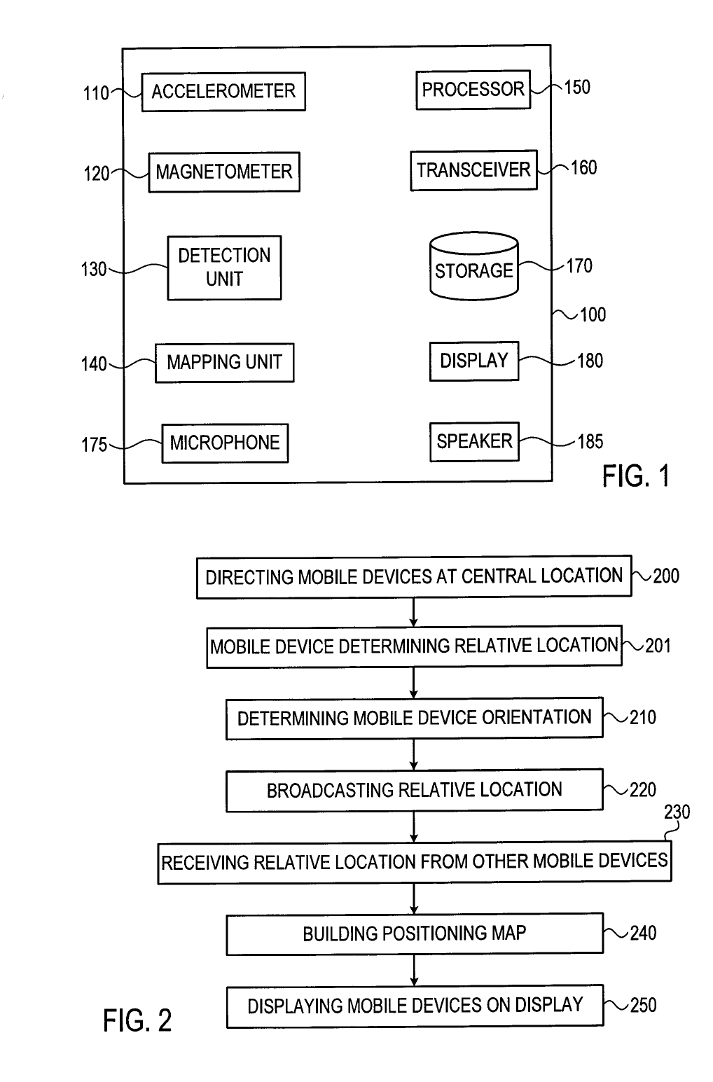

FIG. 1 shows a system on a mobile device for creating a positioning map and transmitting data to other mobile devices, according to some exemplary embodiments of the subject matter. The mobile device 100 is one of the two or more mobile devices connected to each other and transfer data there between. The mobile device 100 comprises an accelerometer 110, which is used to collect a proper acceleration, i.e. g-force, of the mobile device 100. In some exemplary cases, the accelerometer 110 may be used in tandem with a gyroscope (not shown) to collect data regarding the orientation of the mobile device 100. In other exemplary cases, the accelerometer 110 and the gyroscope function in tandem to collect more accurate orientation data. The orientation data is transferred to a processor 150, which determines the proper acceleration or orientation of the mobile device 100.

The mobile device 100 further comprises a magnetometer 120, which is used to collect a magnetic azimuth value of the mobile device 100. The magnetometer 120 collects a three dimensional magnetic value of the mobile device 100, which is used to calculate a magnetic azimuth value by the processor 150. The magnetic azimuth value and proper acceleration determined by the processor 150 enable the processor 150 to determine relative location, which is a direction of one mobile device of the two or more mobile devices from the mobile device 100. The relative location between a pair of mobile devices is broadcasted by a transceiver 160 to other mobile devices of the two or more mobile devices with which the mobile device 100 is attempting to connect. The transceiver 160 receives positioning data, such as magnetic azimuth values, which are broadcasted by other mobile devices of the two or more mobile devices that are attempting to connect to the mobile device 100. The positioning data received by the transceiver 160 enables the mobile device 100 to create a positioning map. In some exemplary embodiments of the subject matter, the transceiver 160 may use Bluetooth, Wi-Fi, or the like. The transceiver 160 is used to transfer and receive data between the mobile device 100 and the other mobile devices, for example media files, documents, play a multiplayer game, e-mails, texts, web links, YouTube films, and the like.

The mobile device 100 comprises a detection unit 130, which is used to detect commands performed by the user of the mobile device 100 to input commands to the mobile device 100. For example, the command may be to transfer data to another mobile device of the two or more mobile devices. In some cases, the detection unit 130 may be a touchscreen or a graphic user interface. The command may be inputted by the user using a finger to create a movement on the screen, such as a sliding gesture. In some cases the movement may be to designate a file to be sent to a target mobile device. The user then drags or slides the file across the graphic user interface of the mobile device to the target mobile device to transfer the file to the receiving mobile device.

The mobile device 100 comprises a mapping unit 140, which creates the positioning map according to the data obtained by the magnetometer 120 and the accelerometer 110, and the data received by the transceiver 160. Using the data received by the transceiver 160 from the other mobile devices, the mobile device 100 determines locations of the other mobile devices relative to the location of the mobile device 100. The mapping unit 140 transmits the positioning map to a display 180 to display the positioning map and the data required to the user to transfer data to another mobile device displayed on the positioning map. In some cases the display 180 is part of the detection unit 130 and the user uses the positioning map displayed on the display 180 to transmit and receive data from other mobile device on the positioning map. In some exemplary embodiments of the subject matter, the positioning map is not displayed on the display 180, but is maintained by the mapping unit 140. When the detection unit 130 receives a movement to transmit data, the processor 150 obtains the relative location of a target mobile device from the mapping unit 140 and uses the relative location to transmit the data to the target mobile device. The display 180 may show a list of mobile devices connected to the mobile device 100 and the movement designates one mobile device from the list of mobile devices.

The mobile device 100 comprises a storage 170, which stores transferable and received data stored on the mobile device 100. The storage 170 may store location data of the mobile device 100 and location data of the other mobile devices to which the mobile device 100 is connected. The processor 150 transfers data from the storage 170 to the transceiver 160. The processor 150 receives a command from the detection unit 130 to transfer data stored in the storage 170 to the transceiver 160. The processor 150 transfers to the transceiver 160 the location data of the receiving mobile device so the data being transferred from the storage 170 is transmitted to the correct receiving mobile device. The mobile device 100 may comprise a microphone 175 and a speaker 185 to enable the mobile device to build its positioning map. The microphone 175, the speaker 185, and the transceiver 160 may be used to determine the distances between every two mobile devices by determining the amplitude and time differential of the receiving waves, i.e. radio frequency and audio, to determine the relative location of other mobile devices.

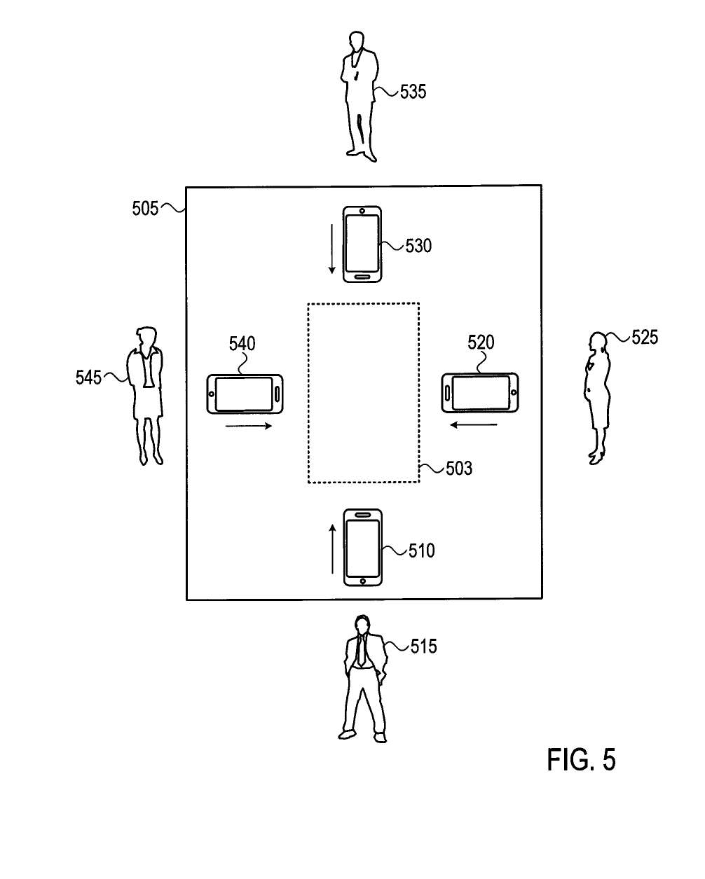

FIG. 2 shows a method performed on two or more mobile devices to connect the two or more mobile devices, according to some exemplary embodiments of the subject matter. Step 200 discloses obtaining two or more mobile devices directed towards a central region. The two or more mobile devices are arranged to face at a central region, which enables determining the relative location of the two or more mobile device relative to the central region. In some cases, the central region may be a center of a table where the two or more mobile devices are arranged to face towards the center of the table. In such a case, as detailed in FIG. 5, two or more persons sit around the table, in front of the central region, each of the persons is associated with a mobile device of the two or more mobile devices. In other cases, the central region may be the front of a classroom, where the two or more mobile devices are arranged to face towards the front of the classroom.

Step 201 discloses the two or more mobile devices determining a relative location of each mobile device relative to the two or more mobile devices. A mobile device of the two or more mobile devices, such as mobile device 100 of FIG. 1, obtains the position of the mobile device using the accelerometer 110 of FIG. 1 or magnetometer 120 of FIG. 1 or a combination of both. The mobile device 100 determines the position according to the proper acceleration and magnetic azimuth value obtained by the processor 150. Step 210 discloses determining device orientation. A mobile device determines the mobile device's orientation using the proper acceleration. The data recorded by the accelerometer 110 enables the processor 150 to determine whether the mobile device 100 is lying on a table top or is held in a different orientation, for example at a forty-five degree angle in a user's hand.

Step 220 discloses broadcasting relative location to other devices. The mobile device 100 determines the magnetic azimuth value to determine the position of the mobile device 100. The mobile device 100 broadcasts the relative location of the mobile device 100 using the transceiver 160 of FIG. 1 to the two or more mobile devices while the two or more mobile devices transmit location data. Step 230 discloses receiving location data from other mobile devices. The mobile device 100 receives location data from other mobile devices. Step 240 discloses building a positioning map. The mapping unit 140 of FIG. 1 creates a positioning map that maintains and updates the location data of the mobile devices connected together. Step 250 discloses displaying the mobile devices on the display 180 of FIG. 1. The processor 150 transfers the positioning map created by the mapping unit 140 to the display 180, to enable the user of the mobile device 100 to view the location of the mobile devices, and to transfer and receive data to the mobile devices connected to the mobile device 100.

In some exemplary embodiments of the subject matter, the central region cannot be determined, for example, in an open room with people walking around, a shopping center, and the like. In such exemplary embodiments, the positioning map is created using the microphone 175 of FIG. 1 and the speaker 185 of FIG. 1 of the mobile device 100 in tandem with the transceiver 160, the accelerometer 110 and the magnetometer 120. The microphone 175, the speaker 185, and the transceiver 160 are used to determine the distances between every two mobile devices by determining the amplitude and time differential of the receiving waves, i.e. radio frequency and audio, from other mobile devices. The mobile device 100 detects direction and duration of movement using the accelerometer 110 and the magnetometer 120. The mobile device 100 determines the distances before and after the movement to build the positioning map. The positioning map constantly updates every time a movement is detected by the accelerometer 110 and the magnetometer 120.

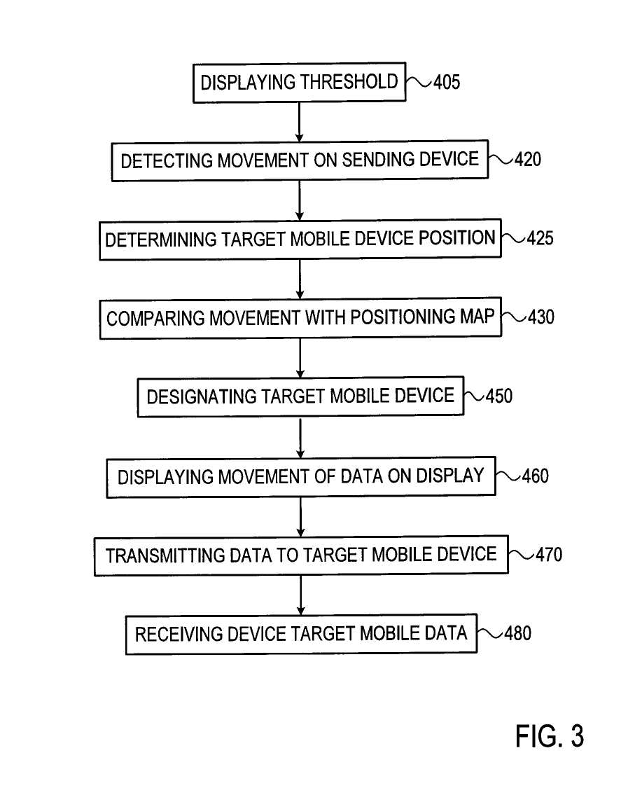

FIG. 3 shows a method performed on a sending mobile device to transfer data between the sending mobile device and a target mobile device, according to some exemplary embodiments of the subject matter. Step 405 discloses displaying a threshold. The threshold may be displayed on a sending mobile device display to show an area associated with a relative location of a target mobile device. The threshold may be two or more lines defining areas associated with a target mobile device. If the movement is at least partially within the area, the mobile device associated with the area may receive the data from the sending mobile device. Step 420 discloses receiving a movement. The detection unit 130 receives a movement performed on the detection unit 130. The movement may be in the form of a sliding gesture, where the user's finger is dragged across the detection unit 130 from a display of the designated data to a display of the target mobile device. For example, the designated date is displayed in the form of a file display on the display 180 of FIG. 1, the user places a user's finger on the file display and moves the user's finger in a sliding gesture towards the display of the target mobile device. In some cases, the movement may be a touch gesture of some other form such as tapping, flicking, or the like. In some cases, the movement also includes moving the sending mobile device on a specific direction, or tilting the sending mobile device at a specific direction.

Step 425 discloses determining the target mobile device position. The sending mobile device determines the relative location of the target mobile devices according to the relative location broadcasted by the target mobile device to determine a positioning map. Step 430 discloses comparing the movement with the positioning map. The processor 150 of FIG. 1 compares the movement collected by the detection unit 130 with the location of the target mobile device and other mobile devices represented on the positioning map. Step 450 discloses designating the target mobile device. The processor 150 designates the target mobile device receive the designated data. The processor 150 determines whether the movement was in a direction of the target mobile device or within a threshold range in which the target mobile device is located.

Step 460 discloses displaying movement of data on the display 180 of FIG. 1. The processor 150 transfers to the display 180 a command to display the transfer of the data as it is dragged from the location of the data on the display 180 to the location of the target mobile device on the display 180. In some exemplary embodiments the movement of the data is performed in real time, for example while the user drags the finger across the detection unit 130 the display 180, which is also the detection unit 130, displays the movement of a file to the target mobile device. In other cases, the user inputs two movements simultaneously to two different mobile devices, and there are two target mobile devices.

Step 470 discloses transmitting the data to the target mobile device. The processor 150 transfers the data designated to be transferred and the target mobile device location data to the transceiver 160 of FIG. 1. The transceiver 160 transmits the data to the target mobile device according to the location data received by the processor 150. Step 480 discloses the target mobile device receiving the data. After the target mobile device receives the designated data, the designated data may appear on a target mobile device display, which informs the target mobile device user that the designated data has been received by the target mobile device.

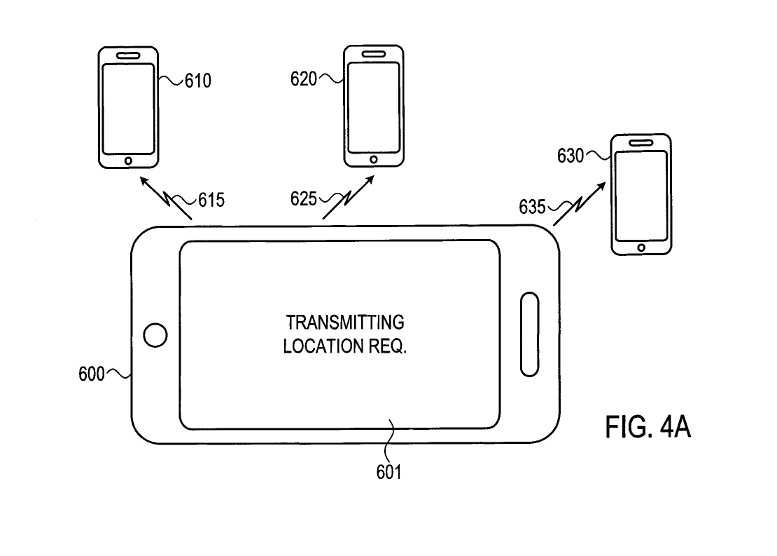

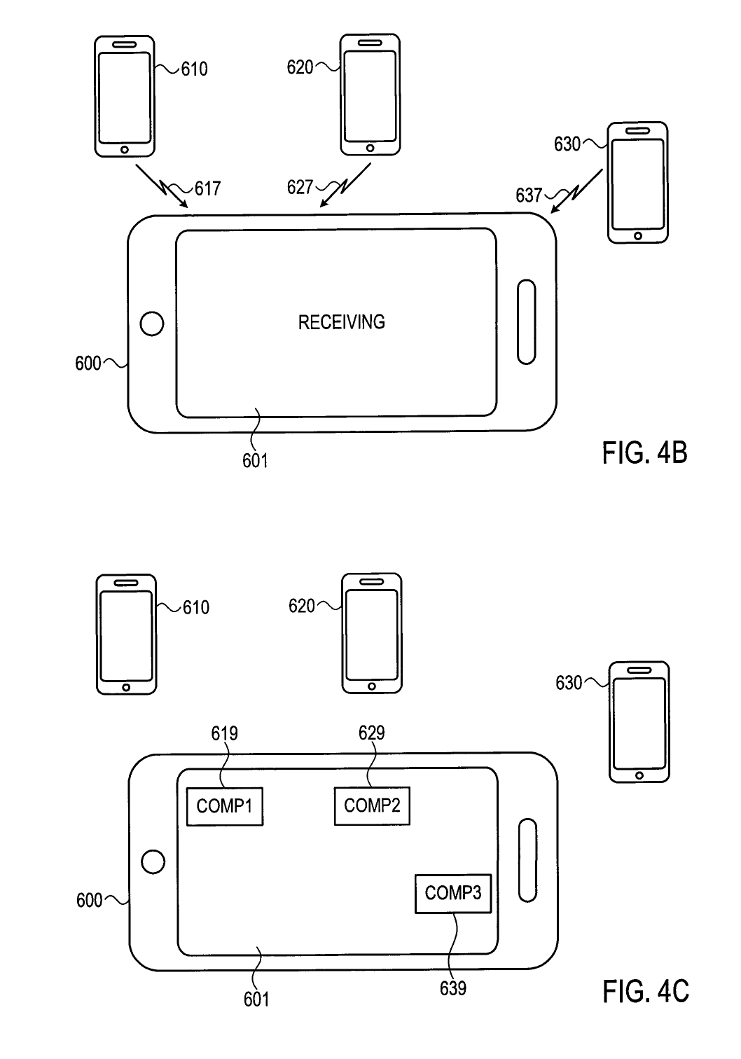

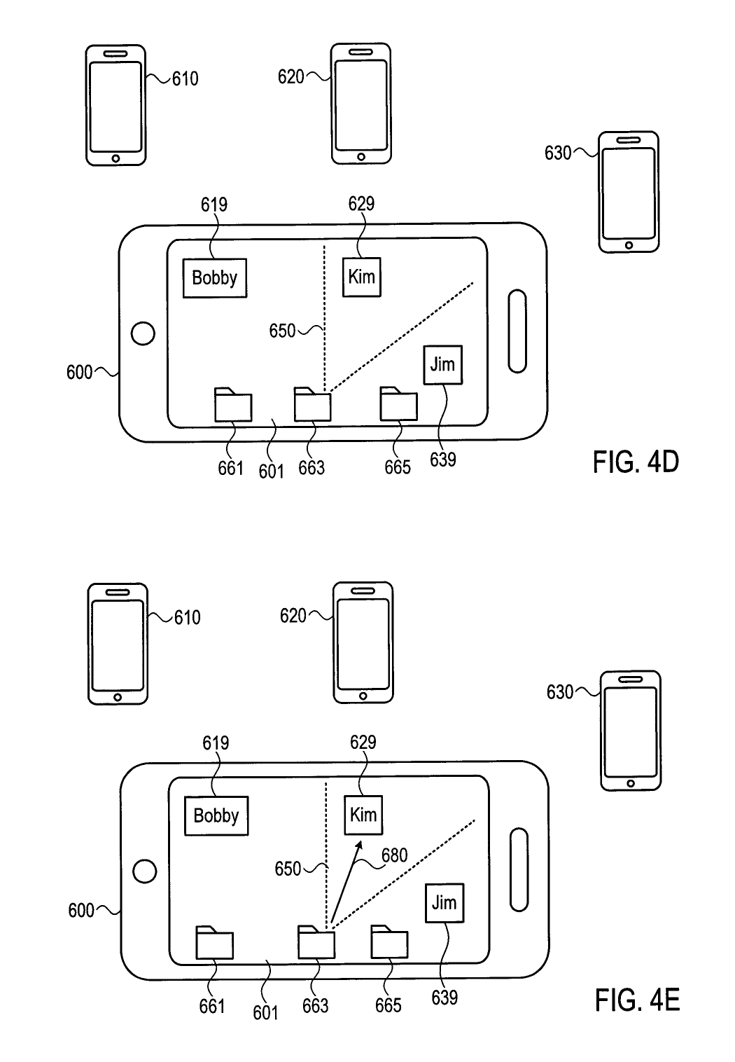

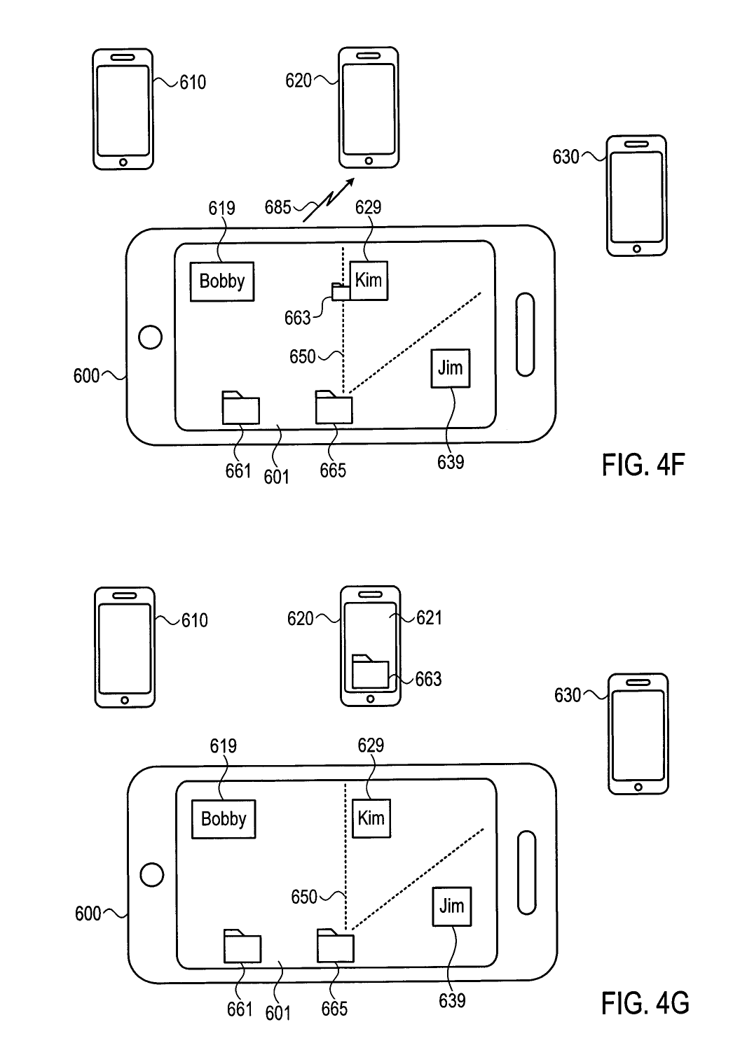

FIG. 4A-4G show connection of a mobile device to three other mobile devices to create a positioning map and to transfer data between the mobile device and a second mobile device of the three mobile devices, according to some exemplary embodiments of the subject matter. FIG. 4A shows a sending mobile device 600 transmitting location requests 615, 625, 635 to three mobile devices 610, 620, 630 that are located near the mobile device 600. The three mobile devices 610, 620, 630 may also transmit relative location requests to one another and to the sending mobile device 600. FIG. 4B shows the sending mobile device 600 receiving relative locations 617, 627, 637 from the three mobile devices 610, 620, 630. FIG. 4C shows the mobile device 600 displaying a positioning map comprising three mobile device representations 619, 629, 639 of the three mobile devices 610, 620, 630 respectively on a display 601. FIG. 4D shows the sending mobile device 600 displaying a positioning map on the display 601. The positioning map comprises of the three mobile device representations 619, 629, 639 and data that may be transmitted to the three mobile devices 610, 620, 630. In some cases, the positioning map may comprise specific names for the three mobile device representations 619, 629, 639 according to data transmitted to the sending mobile device 600 with the three mobile devices 610, 620, 630 location data. For example, a first mobile device 610 is displayed as a first mobile device representation 619 with a username “Bobby,” a second mobile device 620 is displayed as a second mobile device representation 629 with a username “Kim,” and a third mobile device 630 is displayed as a third mobile device representation 639 with a username “Jim.” The positioning map may comprise a threshold 650, which shows the area surrounding one of the three mobile devices.

FIG. 4E shows a user inputting a movement performed on the display 601 of the sending mobile device 600 to transmit data to one of the three mobile devices 610, 620, 630. The movement performed may be a sliding gesture 680, for example, the sliding gesture 680 begins from the second file 663, and is performed towards a target mobile device, which is one of the three mobile devices 610, 620, 630, such as the second mobile device 620. The display 601 shows the threshold 650 of the positioning map in which the slide gesture 680 has to be performed for the data to transfer to the second mobile device 620. FIG. 4F shows the mobile device 600 transmitting the data to the second mobile device 620. After the slide gesture 680 of FIG. 4E was performed, the display may show the second file 663 moved to the second mobile device representation 629 on the display 601. At the same time, the mobile device 600 transmits a transmission 685 of the second file 663 to the second mobile device 620. FIG. 4G shows the second file 663 on a second mobile device display 621. This enables a second mobile device user to use the second file 663 as the second mobile device user requires. In some exemplary cases, the mobile device 600 only transfers a copy of the second file 663 to the second mobile device 620.

FIG. 5 shows a configuration of mobile devices around a central region, according to some exemplary embodiments of the subject matter. The central region 503 may be located in a center of a table 505. The central region 503 enables mobile devices arranged near the central region 503 to determine relative locations of each other in order to create a positioning map. Four individuals 515, 525, 535, 545 are sitting around the table 505 with four mobile devices, such as first mobile device 510, second mobile device 520, third mobile device 530, and fourth mobile device 540. The four mobile devices are arranged so the four mobile devices are positioned towards the central region 503. The four mobile devices now may determine the relative location of the four mobile devices. Each mobile device of four mobile devices uses a magnetometer, accelerometer or both to determine the relative location according to the central region 503.

In some exemplary embodiments of the subject matter, a host is designated by the four individuals 515, 525, 535, 545 for storing the positioning map. In such cases, the host may be a mobile device of the four mobile devices, a cloud, remote server, a remote mobile device, or the like. Where the host is designated to store the positioning map, the four mobile devices communicate with the host to receive the relative locations to transmit data. For example, the host is designated as a remote Cloud. The host receives the relative location of the first mobile device 510, the second mobile device 520, the third mobile device 530, and the fourth mobile device 540. After receiving all of the relative locations, the host creates the positioning map and stores it in a storage. In order for one of the four mobile devices to transmit data to another of the four mobile devices, for example, the third mobile device 530 is transmitting data to the second mobile device 520, the third mobile device 530 first requests from the host an identification or address of mobile devices placed in a particular location. The host determines according to the positioning map that mobile device 2 520 is located in a particular location. The host transmits the identification or address of the second mobile device 520 to the third mobile device 530. The third mobile device 530 then transmits the data to the second mobile device 520.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method performed on two or more mobile devices comprising:
detecting a movement on a sending mobile device, said sending mobile device is one of the two or more mobile devices, said movement is performed on the sending mobile device;
comparing the movement performed on the sending mobile device with a positioning map, wherein the positioning map comprises relative locations of the two or more mobile devices;
determining a relative location of the target mobile device on the positioning map;
transmitting the data from the sending mobile device to the target mobile device.

2. The method of claim 1, further comprises arranging the two or more mobile devices towards a central region.

3. The method of claim 1, further comprises designates the target mobile device to receive the data according to the movement.

4. The method of claim 1, wherein the movement is a sliding gesture.

5. The method of claim 1, further comprises designates the target mobile device located according to the movement and an area defined by a threshold, wherein the threshold represents an area in which the sending mobile device detects a relative location of the target mobile device.

6. The method of claim 5, further comprising:
associating a mobile device of the two or more mobile devices with the area according to the relative location of the mobile device of the two or more mobile devices.

7. The method of claim 6, further comprises displaying threshold lines on a display of the sending mobile device.

8. The method of claim 1, further comprises displaying the positioning map on a display of the sending mobile device.

9. The method of claim 1, wherein the positioning map is stored on a host communicating with the two or more mobile devices.

10. The method of claim 1, wherein the positioning map is displayed on the sending mobile device to determine a target mobile device from the two or more mobile devices.

11. The method of claim 1, wherein the positioning map is stored on all of the two or more mobile devices.

12. The method of claim 1, further comprises obtaining a mobile wireless connection between the two or more mobile devices.

13. A system on a mobile device comprises:
a display;
a detection unit for detecting movements on the mobile device;
a processor to determine the position of the mobile device, wherein the position is determined according to the magnetic azimuth value and proper acceleration, wherein the processor determines an orientation of the mobile device;
a mapping unit to create a positioning map according to position data determined by the processor and received position data received by a transceiver, wherein the received position data is received from other mobile devices;
a storage to store positioning map data created by the mapping unit, wherein the storage data stores data received from other mobile devices connected to the mobile device.

14. The system of claim 13, wherein the detection unit comprises:
an accelerometer to collect a proper acceleration;
a magnetometer to collect a magnetic azimuth value of the mobile device.

15. The system of claim 13, wherein the display displays a positioning map and threshold of mobile devices connected to the mobile device.

16. The system of claim 13, wherein the detection unit is a touchscreen.

17. The system of claim 13, further comprising: a microphone; and a speaker.
